(19) United States
(12) Patent Application Publication
(10) Pub. No.: US 2009/0102467 A1
(43) Pub. Date: Apr. 23, 2009

(54) METHOD AND APPARATUS FOR SENSING SHAFT ROTATION

(75) Inventors: Paul W. SNELL, York, PA (US); Dale M. UNGER, York, PA (US)

Correspondence Address: MCNEES WALLACE & NURICK LLC, 100 PINE ST., P.O. BOX 1166, HARRISBURG, PA, 17108-1166, US

(73) Assignee: JOHNSON CONTROLS INC., Holland, MI (US)

(21) Appl. No.: 11/876,205

(22) Filed: Oct. 22, 2007

(51) Int. Cl. G01B 7/30

(52) U.S. Cl. 324/207.25

(57) ABSTRACT

A system or method for sensing rotational parameters of a rotating machine. A rotating element is mounted on a shaft of a rotary machine. The rotating element has predetermined magnetic permeability. An insert is disposed on the first rotating element and characterized by a second magnetic permeability different from that of the rotating element. A sensor is mounted opposite the first rotating element and separated from the rotating element by a gap. The target element has an axis substantially parallel with and offset from the axis of the rotating element. The sensor is disposed in substantial alignment with the target element at least once per rotation when the rotating element is rotating. The sensor is configured to generate an output signal in response to a sensed deviation in a magnetic field induced by the rotation of the target element in proximity to the sensor.

### BACKGROUND

The application generally relates to a method and apparatus for sensing rotating motion of a shaft. The application relates more specifically to sensing rotating motion of a shaft with an eddy current sensor responsive to an insert integrated in the shaft having magnetic properties varying from the shaft material.

Laser technology may be used to sense rotational movement of a smooth shaft, but the laser beam normally requires a clean environment and a reflective element for sensing. In industrial environments, the laser beam sensor may not function reliably. In addition, laser type sensors are not applicable for use in grease filled, or oil filled environments. Another technique for sensing rotational movement is by use of a magnetic sensor. A magnetic sensor tends to collect metallic debris, e.g., metal filings and small parts such as screws or washers, possibly damaging the shaft or bearing. In addition, a magnetic sensor has a limited range of operating temperatures, may set up a generator inside the bearing leading to electric arcing which may forming grooves or otherwise damage the shaft or bearing.

Eddy-current sensors are used in rotating machinery applications to detect the shaft position and/or the rotational speed of a machine, e.g., an electric motor or combustion engine. Eddy current sensors are also known as “proximity probes” and “non-contact vibration probes”. An eddy-current sensor typically has an inductance coil that, when provided with a high frequency electrical current, generates a magnetic field. This magnetic field induces eddy currents on a conductive target that is disposed within the magnetic field. The target may be stationary or moving into or through the magnetic field. These eddy-currents affect the amplitude of the magnetic field. The eddy-current sensor, in conjunction with signal-conditioning electronics, detects the changes in the magnetic field and generates an output signal that is proportional to the static distance or gap between the sensor and the target. The output signal is also proportional in relation to the dynamic change in distance, i.e., movement or vibration, with respect to the sensor location.

The output signals from eddy-current sensors are dependent upon a variety of properties of the target material, including the conductivity and permeability of the target, and any surface irregularities that may be present on the target. Eddy-current proximity probes are used in a wide variety of applications, e.g., for detection of an item within a field, for distance detection and measurement, and for vibration measurement. One known application in rotating machinery is the measurement of shaft rotational velocity by sensing the movement of a physical anomaly, e.g., a groove, an aperture, or a raised section of a shaft, through the sensor field. Physical perturbations of the target material such as those noted above are impractical in certain applications. One example of such an impractical application is where the target that is to be sensed by the eddy-current sensor is a bearing surface, and physical perturbations such as grooves, holes, or raised sections can interfere with the rotation or other mechanical function of the bearing.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a system for sensing rotational parameters of a rotating device. The system includes a rotating element having a substantially smooth surface mounted on a shaft of the rotating device. The rotating element has a first set of magnetic properties. A target element is disposed integrally with the rotating element. The target element has a surface substantially continuous with the rotating element smooth surface. The target element has a second set of magnetic properties distinct from the first set of magnetic properties. A first sensor is mounted opposite the rotating element and spaced apart from the rotating element. The first sensor is in substantial alignment with the target element at least once per rotation of the rotating element. The target element has an axis substantially parallel with and offset from an axis of the rotating element. The first sensor is configured to generate an output signal in response to a sensed variation in a magnetic field induced by the rotation of the target element in proximity to the first sensor.

Another embodiment relates to a thrust collar assembly for attachment to a shaft of a rotating machine. The thrust collar assembly includes a rotating element that has a generally smooth surface. The rotating element having a first set of magnetic properties. A target element is disposed integrally with the rotating element. The target element has a surface substantially flush with the surface of the rotating element. The target element has a second set of magnetic properties distinct from the first set of magnetic properties. The one target element also has an axis substantially parallel with and offset from an axis of the rotating element.

A further embodiment is directed to a method for measuring rotational frequency of a rotating machine. The method includes providing a rotary surface along a shaft of the rotating machine; boring in the rotary surface at least one recess a distance away from a rotational axis of the rotating machine, for receiving at least one target element; selecting a target material for the at least one target element having magnetic properties distinct from the rotary surface; inserting in the at least one recess of the rotary surface the at least one target element; positioning a magnetic sensor opposite the at least one target element; generating a signal responsive to and proportional to a magnetic field induced by the magnetic properties of the rotary surface and the at least one target element respectively; and calculating the rotational frequency of the rotating machine based on the generated signal.

Still another embodiment is directed to a system for sensing rotational parameters of a rotating machine. The system includes a rotating shaft having a substantially smooth surface. The rotating shaft has a first set of magnetic properties. A target element is integrally disposed within the shaft. The target element has a surface substantially flush with the surface of the rotating shaft. The target element has a second set of magnetic properties distinct from the first set of magnetic properties. A sensor is mounted adjacent to the shaft, spaced apart from the shaft by a gap. The target element has an axis substantially perpendicular to an axis of the shaft, with the sensor being disposed in substantial alignment with the target element at least once per rotation of the shaft. The sensor generates an output signal in response to a sensed variation in a magnetic field induced by the rotation of the target element in proximity to the sensor.

Certain advantages of the embodiments described herein are a signal is obtainable that is proportionally relative to the speed of a rotating object, without disturbing the symmetry of the object, or introducing dimensional discontinuities in the surface of the object.

Another advantage includes a target that can be a smooth shaft or collar free from physical grooves or holes or slots for the purpose of detecting rotational velocity.

A further advantage is that the target shaft may be an active bearing surface that may be completely flooded with oil or other fluid.

Another advantage is the sensed target can be inserted within a bearing or collar and provide for shorter shafts or more compact designs.

Alternative exemplary embodiments relate to other features and combinations of features as may be generally recited in the claims.

### BRIEF DESCRIPTION OF THE FIGURES

FIG. 1 is an elevational view of an exemplary thrust collar.

FIG. 2 is a sectional view taken along the lines 2-2 in FIG. 1.

FIG. 3 is a graph showing a periodic magnetic impulse versus time.

FIG. 4 is a method flow diagram.

FIG. 5 is a schematic diagram of the invention with two magnetic sensors and multiple targets arranged on a rotating surface at different radii.

FIG. 6A is a probe output waveform corresponding to the target arrangement of FIG. 5, when the surface is rotating in a clockwise direction.

FIG. 6B is a probe output waveform corresponding to the target arrangement of FIG. 5, when the surface is rotating in a counterclockwise direction.

FIG. 7 is an alternate embodiment of a schematic diagram of multiple targets arranged on a rotating surface and a single magnetic sensor.

FIG. 8A is a probe output waveform corresponding to the target arrangement of FIG. 7, when the surface is rotating in a clockwise direction.

FIG. 8B is a probe output waveform corresponding to the target arrangement of FIG. 7, when the surface is rotating in a counterclockwise direction.

FIG. 9 is another schematic diagram of the invention with a single magnetic sensor and two targets of different sizes.

FIG. 10A is a probe output waveform corresponding to the target arrangement of FIG. 9, when the surface is rotating in a clockwise direction.

FIG. 10B is a probe output waveform corresponding to the target arrangement of FIG. 9, when the surface is rotating in a counterclockwise direction.

FIG. 11 is an alternate embodiment of the invention with the target inserted in a rotating shaft.

### DETAILED DESCRIPTION OF THE EXEMPLARY EMBODIMENTS

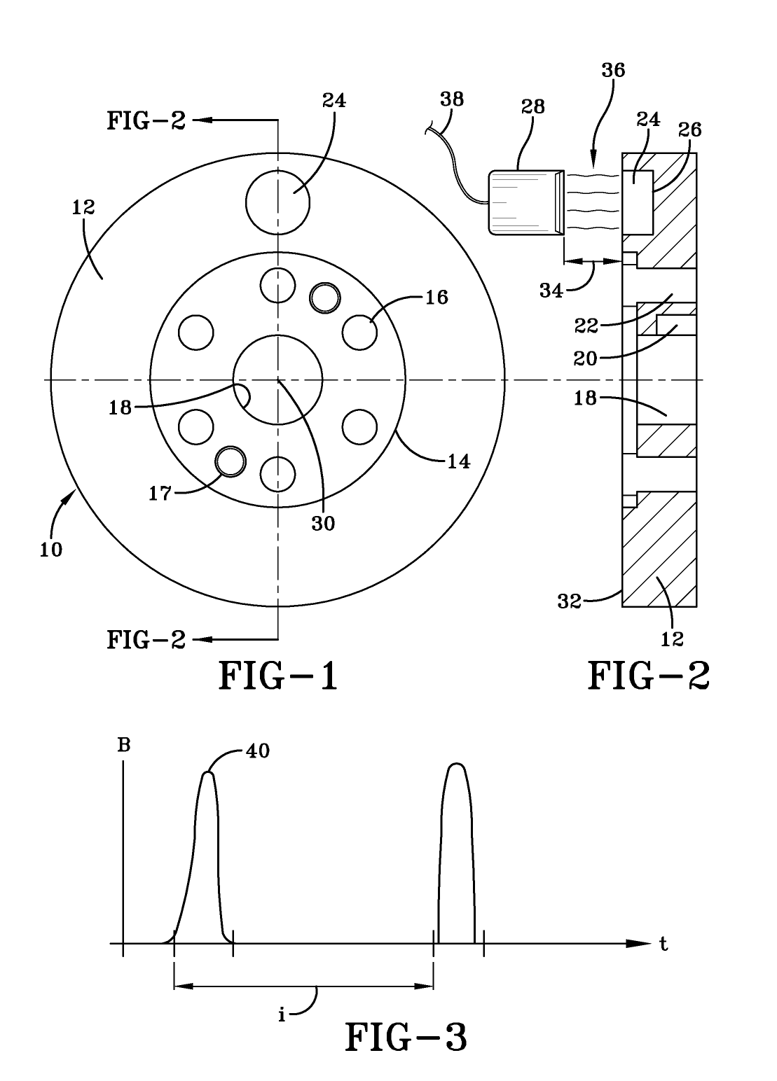

In FIGS. 1 and 2, the disclosed embodiment includes a novel application of an eddy-current proximity probe that senses a difference in magnetic properties of a rotating surface, and is used to detect and measure motion of a shaft. Referring to FIGS. 1 and 2, the disclosed embodiment includes a novel application of an eddy-current proximity probe that senses a difference in magnetic properties of a rotating surface, and is used to detect and measure motion of a shaft. A substantially smooth rotating device 10, e.g., a thrust bearing or a seal, includes a thrust collar surface 12 and a counterbore surface 14. Loading screws 16 are inserted through screw holes 22 drilled through the counterbore surface 14, for threaded attachment to another rotating device, such as a rotor or a fan blade (not shown) attached to a drive shaft 18. The counterbore surface 14 also includes a pair of internally threaded holes 17 for pulling the rotating device from a drive shaft 18. Drive shaft 18 is rotatably fixed to the thrust collar 10 by a keyway and key 20.

The thrust collar surface 12 includes a counter bored recess 26 that is dimensioned to receive an insert plug or target element 24. The shape of counter bored recess 26 is shown in a substantially rectangular cross section, although various cross-sectional shapes may be used, e.g., having rounded, partially-rounded, or tapered bottom surfaces, corresponding to the tools used to drill or bore the recess 26. The insert plug 24 is formed from a material having substantially different magnetic properties, e.g., conductivity or permeability, from the magnetic properties of the outer collar ring material. In one embodiment, the thrust collar surface 12 may be constructed of carbon steel 4340, and the insert plug constructed of stainless steel 414. Stainless steel possesses different magnetic properties from those of the parent material in the thrust collar surface 12.

In the above embodiment, the insert plug 24 is capable of performing the mechanical function of the carbon steel thrust collar surface 12. Insert plug 24 is inserted into counter bored recess 26 in the surface of thrust collar surface 12 with an interference fit. Surface 32 of the shaft 18 and thrust collars 10 is then machined smooth such that the insert plug 24 is flush with and has the same surface finish as the surface of outer collar ring 12.

A magnetic sensor or pickup 28 is positioned opposing and generally coaxially with the insert plug 24. Insert plug 24 and sensor 28 are axially offset from rotary axis 30 of coaxially arranged shaft 18 and thrust collar 10. In the example thrust collar 10, insert plug 24 is positioned outside the perimeter of the inner ring, although insert plug 24 and counter bored recess 26 may be located anywhere along the radius that is not substantially coaxial with shaft 18 and thrust collar 10.

Insert plug 24 passes adjacent to magnetic sensor 28 once per shaft rotation, although in alternate embodiments, more than one insert plug may be positioned at predetermined intervals if a higher frequency magnetic impulse is desired. A change in the magnetic field is caused by the target material of insert plug 24 having differing magnetic properties from the material of thrust collar 10, as insert plug 24 passes the sensor during rotation. An impulse is created in the sensor output signal due to the different magnetic properties of the two metals causing perturbations in magnetic field 36 associated with each of the target and outer collar ring materials, as they rotate adjacent to sensor 28. Sensor 28 is connected via cable or other transmission medium (e.g., wireless transmitter) to a controller (not shown) for processing the impulse signal. The processed signal may be used, e.g., for providing a feedback control loop for controlling the speed of a rotating motor or engine; for a speedometer display; or to detect an overspeed condition.

Referring to FIG. 3, pulses 40 are illustrated along a time function graph corresponding to the passage of insert plug 24 by magnetic sensor 28. Impulse 40 appears at time intervals i that vary inversely proportionally to the rotational velocity of shaft 18. The impulse spacing can thus be used to detect and measure whether shaft 18 is rotating, and to determine the rotational velocity of shaft 18. Further, impulse 40 may be used as a phase reference for various purposes, such as for rotating machinery vibration diagnostics, when employed in conjunction with additional vibration sensors. With the above-described embodiment, a useful signal output is generated without introducing physical abnormalities or dimensional discontinuities in surface 32, which provides the advantageous ability to locate the insert plug 24 within a bearing or collar 10.

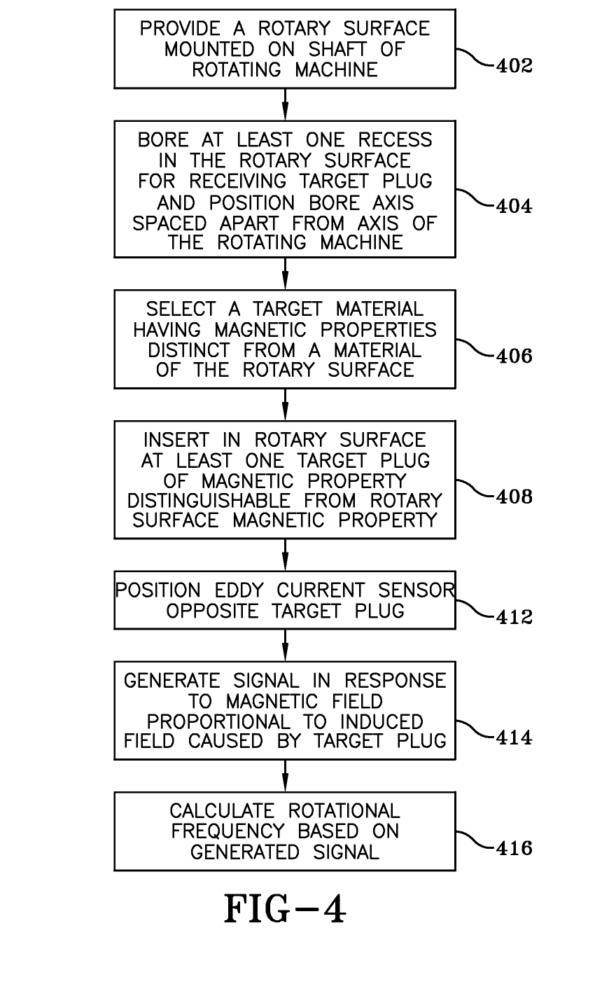

Referring next to FIG. 4, there is a diagram showing one embodiment of a method for measuring rotational frequency of a rotating machine. The method includes providing a rotary surface along a shaft of the rotating machine (step 402). Next, at least one recess is bored in the rotary surface at to receive a target element, such that the inserted target element axis is spaced at a distance from a rotational axis of the rotating machine and parallel thereto (step 404). A target material is then selected for the target element having magnetic properties distinct from the material from which the rotary surface is constructed (step 406). The target element is inserted in the rotary surface (step 408). The magnetic sensor is positioned opposite the target element or elements (step 412). The magnetic sensor is configured to generate a signal responsive to and proportional to a magnetic field induced by the magnetic properties of the rotary surface and the target element respectively (step 414). As the machine rotates, the magnetic generates a signal indicative of the magnetic field sensed by the sensor. Next, the system calculates the rotational frequency based on generated signal (step 416). In one embodiment, the method may further include finishing the surface of the rotary element and the surface of the target element to a flush, polished microfinish surface.

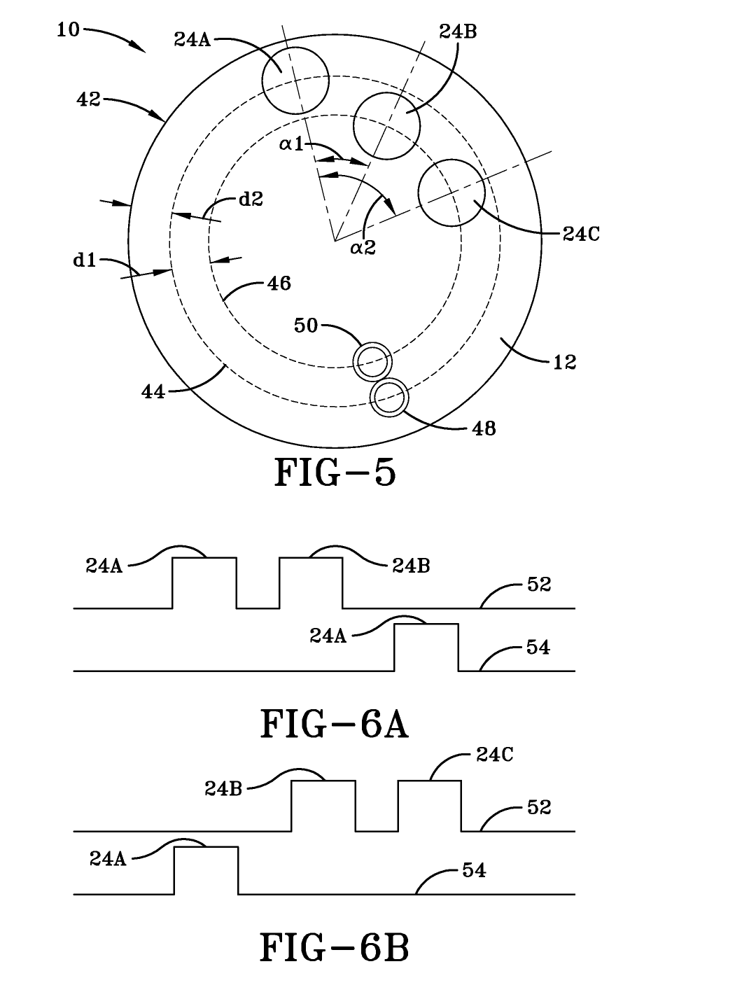

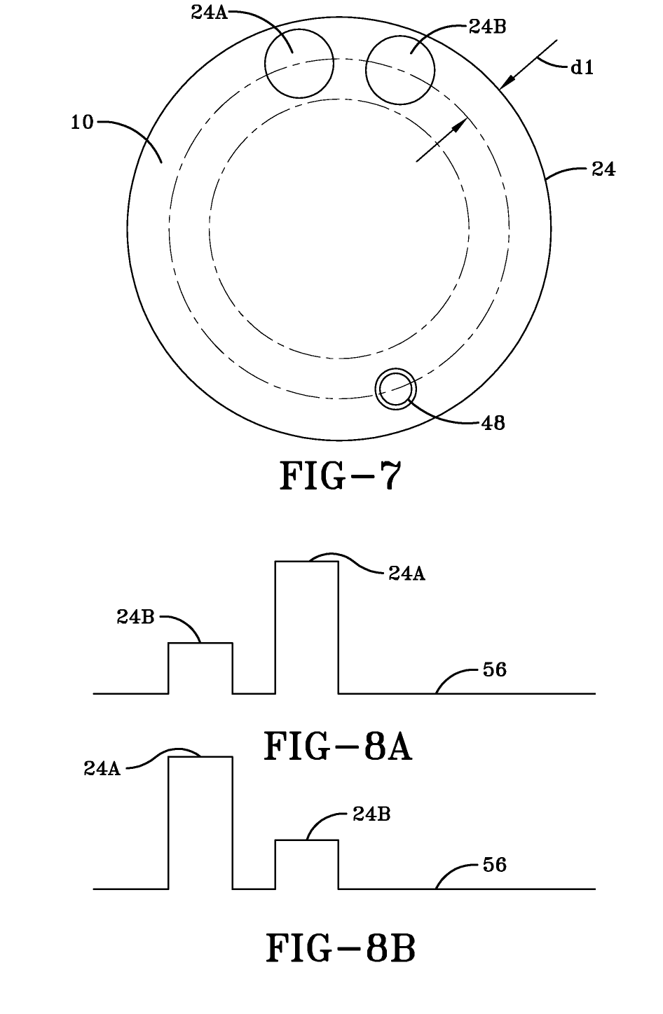

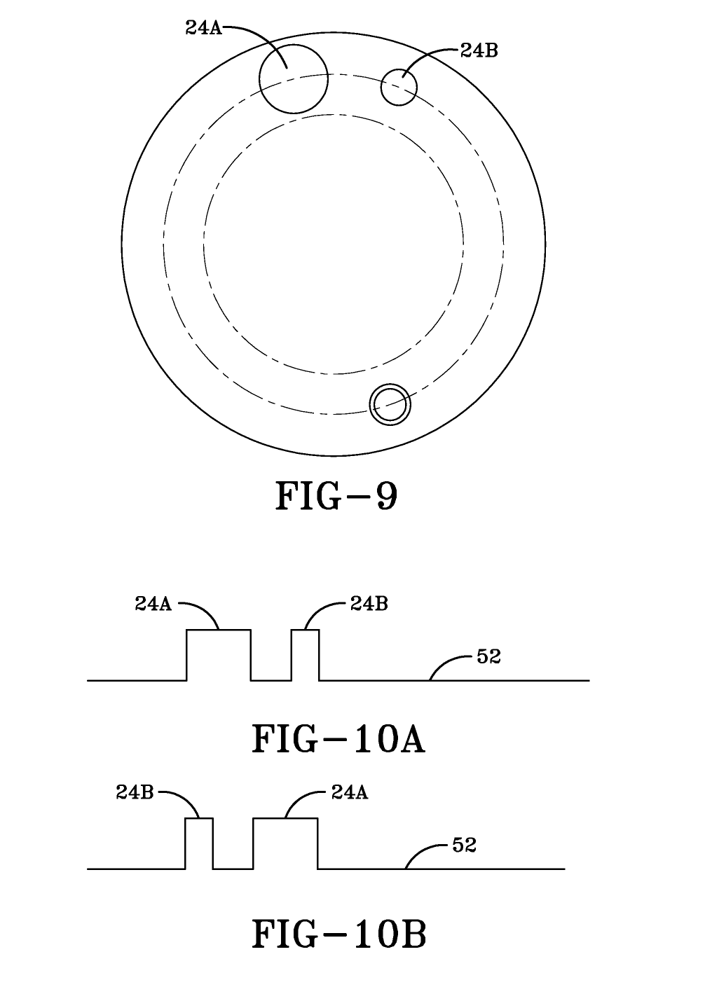

Several exemplary embodiments in FIGS. 5-10 are provided to show multiple insert plugs arranged on a rotating device 10 for detecting the direction of rotation of rotating device 10, as well as the rotational velocity. Referring first to FIG. 5, a first insert plug 24a is located in thrust collar surface 12 at a predetermined radial distance d2 from outer edge 42 which follows first rotational path 44 when device 10 is rotating. A second insert plug 24b and a third insert plug 24c are located in thrust collar surface 12 at a predetermined radial distance d1 from the first rotational path 44, and follow a second rotational path 46 when device 10 is rotating. First insert plug 24a is located at a position that is offset radially from the positional angles of insert plugs 24b, 24c, indicated by α1 and α2. Stationary probe positions 48, 50 correspond to points along each of the first and second paths 44, 46, respectively. Insert plug 24a passes adjacent first sensor probe 28 at location 48 once per revolution; and each of insert plugs 24b and 24c pass adjacent second sensor probe 28 at location 50 once per revolution. The magnetic properties of the insert plugs 24a, 24b, 24c cause the sensor probes 28 at locations 48, 50 to generate pulses corresponding to the time that the respective insert plugs 24a, 24b and 24c pass proximate to sensor probes 28 at locations 48 and 50, respectively. The resulting waveforms of the sensor output signals is shown in FIGS. 6A and 6B. For a clockwise rotation as shown in FIG. 6A, waveform 52 includes two square waves or pulses corresponding to probe 28 at location 50 and waveform 54 includes a single square wave or pulse lagging the pulses of waveform 52 corresponding to probe 28 at location 48. The asymmetrical arrangement of insert plugs 24a, 24b and 24c, provides a long interval before the wave sequences repeat, which indicates which pulse or pair of pulses is appearing first in the sequence. Referring to FIG. 6B, the rotation of device 10 is counterclockwise, so pulse waveform 54 leads pulse waveform 52. FIG. 7 illustrates an alternate embodiment for sensing rotational direction. Insert plugs 24a and 24b and probe 48 lie in the same path at a radial distance d1 from edge 24. In FIG. 7, insert plugs 24a and 24b are made of magnetically distinct materials, and each plug 24a, 24b generates a substantially different output from the probe 48 as the plugs 24a and 24b pass by the probe 48 in sequence. As shown in FIGS. 8A and 8B, the pulses induced in the sensor output waveform 56, differ in magnitude, thereby indicating which plug 24a, 24b, passes the sensor position 48 first, and the direction in which the device 10 is rotating. Referring next to FIGS. 9 and 10, in this alternate embodiment, insert plugs 24a and 24b are made of similar magnetic material. Plugs 24a, 24b have different diameters, creating a responsive waveform 52 having an identifiable longer or shorter pulse, respectively, as shown in FIGS. 10A and 10B. It will be appreciated by those skilled in the art to modify the arrangement of the insert plugs in various other ways, similar to the examples set forth in FIGS. 5 through 10, to achieve the same results for determining rotational direction.

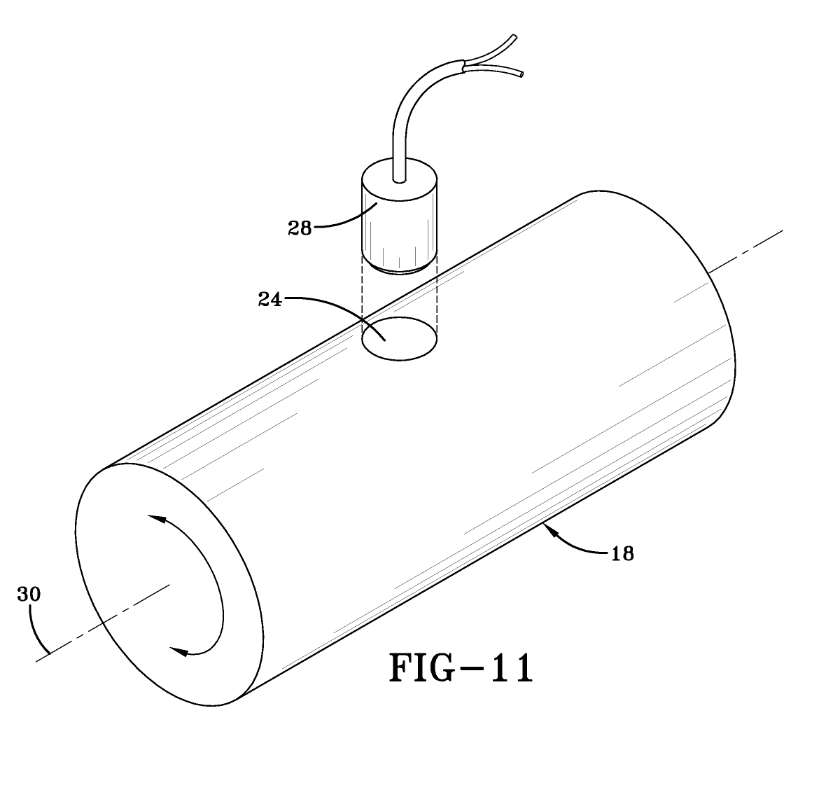

FIG. 11 is an embodiment of the invention with the target 24 inserted directly into a rotating shaft 30. The target 24 is machined flush with the rotating surface of the shaft 18. In this embodiment, the sensor 28 is directed at the target 24 and is aligned substantially perpendicular to the axis 30 of the shaft rotation. The embodiment of FIG. 11 may be employed, e.g., where no thrust collar or bearing is attached to a shaft, or where there is insufficient space at the distal end of the shaft 30 for placement of an axially aligned sensor 18. As described in the embodiments discussed in FIGS. 1 through 10B, the target is placed into a counter bored recess (not shown) of the shaft, and then machined and polished to a flush, microfinished surface, with an interference fit.

It should be understood that the application is not limited to the details or methodology set forth in the following description or illustrated in the figures. It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the method and apparatus for sensing rotating motion of a shaft as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should also be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule-based logic and other logic to accomplish the various connection steps, processing steps, comparison steps and decision steps.

What is claimed is:

1. A system for sensing rotational parameters of a rotating device comprising:
a rotating element having a substantially smooth surface mounted on a shaft of the rotating device, the rotating element having a first set of magnetic properties;
at least one target element disposed integrally with the rotating element and having a surface that is substantially continuous with the rotating element smooth surface, the at least one target element having a second set of magnetic properties distinct from the first set of magnetic properties;
a first sensor mounted opposite the rotating element and being spaced apart from the rotating element, the first sensor being in substantial alignment with the at least one target element at least once per rotation of the rotating element;
the at least one target element having an axis substantially parallel with and offset from an axis of the rotating element; and
the first sensor being configured to generate an output signal in response to a sensed variation in a magnetic field induced by the rotation of the at least one target element in proximity to the first sensor.

2. The system of claim 1, wherein the at least one target element is comprised of stainless steel and the rotating element is comprised of carbon steel.

3. The system of claim 1, wherein the rotating element further comprises a counter bored recess configured to receive the at least one target element in an interference fit.

4. The system of claim 1, wherein the rotating element is a thrust collar.

5. The system of claim 1, wherein the rotating element is a bearing.

6. The system of claim 1, wherein the at least one target element and the rotating element have a microfinish polish.

7. The system of claim 1, wherein the output signal is an impulse having a periodic frequency matching a rotational frequency of the shaft.

8. The system of claim 7, wherein the impulse is generated by the variation in magnetic field caused by the different magnetic properties associated with the rotating element and the at least one target element.

9. The system of claim 1, wherein a mechanical function of the at least one target element is equal to or greater than a mechanical function of the rotating element, and wherein the integration of the at least one target element and the rotating element has a substantially equal mechanical property compared to a rotating element without target elements inserted therein.

10. The system of claim 1, wherein the first and second sets of magnetic properties include permeability.

11. The system of claim 1, further comprising:
a second sensor disposed in substantial alignment with the at least one target element at least once per rotation of the rotating element, the second sensor configured to generate an output signal in response to a sensed variation in a magnetic field induced by the rotation of the at least one target element in proximity to the second sensor;
and wherein the output signals from the first and second sensors provide indication of a direction of rotation of the rotating element.

12. A thrust collar assembly for attachment to a shaft of a rotating machine, comprising:
a rotating element having a generally smooth surface, the rotating element having a first set of magnetic properties;
at least one target element disposed integrally with the rotating element and having a surface that is substantially flush with the rotating element smooth surface, the at least one target element having a second set of magnetic properties distinct from the first set of magnetic properties; and
the at least one target element having an axis substantially parallel with and offset from an axis of the rotating element.

13. The thrust collar assembly of claim 12, further including:
a sensor mounted opposite the rotating element and being separated from the rotating element by a gap, wherein the sensor is disposed in substantial axial alignment with the at least one target element at least once per rotation of the rotating element, the sensor configured to generate an output signal in response to a sensed variation in a magnetic field induced by the rotation of the at least one target element in proximity to the sensor.

14. A method for measuring rotational frequency of a rotating machine, comprising:
providing a rotary surface along a shaft of the rotating machine;
boring in the rotary surface at least one recess a distance away from a rotational axis of the rotating machine, for receiving at least one target element;
selecting a target material for the at least one target element having magnetic properties distinct from the rotary surface;
inserting in the at least one recess of the rotary surface the at least one target element;
positioning a magnetic sensor opposite the at least one target element; and
generating a signal indicative of the magnetic field sensed by the sensor.

15. The method of claim 14, wherein the step of boring at least one recess further comprises centering the recess on an axis that is parallel to the rotational axis.

16. The method of claim 14, also comprising the step of finishing the surface of the rotary element and the surface of the at least one target element to create a flush surface having a microfinish.

17. A system for sensing rotational parameters of a rotating machine comprising:
a rotating shaft having a substantially smooth surface, the rotating shaft having a first set of magnetic properties;
at least one target element integrally disposed within the shaft and having a surface that is substantially flush with the rotating shaft surface, the at least one target element having a second set of magnetic properties distinct from the first set of magnetic properties;
a sensor mounted adjacent to the shaft and being spaced apart therefrom by a gap;
the at least one target element having an axis substantially perpendicular to an axis of the shaft,
the sensor being disposed in substantial alignment with the at least one target element at least once per rotation of the shaft, the sensor configured to generate an output signal in response to a sensed variation in a magnetic field induced by the rotation of the at least one target element in proximity to the sensor.

18. The system of claim 17, wherein the at least one target element is comprised of stainless steel and the shaft is comprised of carbon steel.

19. The system of claim 17, wherein the shaft further comprises a counter bored recess configured to receive the at least one target element in an interference fit.

20. The system of claim 17, wherein the at least one target element and the shaft have a microfinish polish.

21. The system of claim 17, wherein a mechanical function of the at least one target element is equal to or greater than a mechanical function of the shaft, and wherein the integration of the at least one target element and the shaft has a substantially equal mechanical property compared to a shaft without target elements inserted therein.

22. The system of claim 17, wherein the first and second sets of magnetic properties include permeability.
